(19) United States
(12) Patent Application Publication
(10) Pub. No.: US 2009/0237844 A1
(43) Pub. Date: Sep. 24, 2009

(54) MAGNETIC SENSOR DEVICE FOR AND A METHOD OF SENSING MAGNETIC PARTICLES

(75) Inventors: Haris Duric, Helmond (NL); Josephus Arnoldud Henricus Maria Kahlman, Tilburg (NL); Jeroen Jacob Arnold Tol, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindovhen (NL)

(21) Appl. No.: 12/299,777

(22) PCT Filed: Apr. 27, 2007
(86) PCT No.: PCT/IB2007/051577

§ 371 Date: Nov. 6, 2008

(30) Foreign Application Priority Data
May 9, 2006 (EP) 06113705.5

(51) Int. Cl. G11B 5/33

(52) U.S. Cl. 360/324; G9B/5.104

(57) ABSTRACT

A magnetic sensor device (300) for sensing magnetic particles (15), the magnetic sensor device (300) comprising a magnetic field generator unit (12) adapted for generating a magnetic field, an excitation signal source (302) adapted for supplying the magnetic field generator unit (12) with a static electric excitation signal, an excitation switch unit (303) adapted for switching between different modes of electrically coupling the excitation signal source (302) to the magnetic field generator unit (12), and a sensing unit (11) adapted for sensing a signal indicative of the presence of the magnetic particles (15) in the generated magnetic field.

### FIELD OF THE INVENTION

The invention relates to a magnetic sensor device for sensing magnetic particles.

The invention further relates to a method of sensing magnetic particles.

Moreover, the invention relates to a program element.

Further, the invention relates to a computer-readable medium.

### BACKGROUND OF THE INVENTION

A biosensor may be a device for the detection of an analyte that combines a biological component with a physicochemical or physical detector component.

Magnetic biosensors may use the Giant Magnetoresistance Effect (GMR) for detecting biological molecules being magnetic or being labeled with magnetic beads.

In the following, biosensors will be explained which may use the Giant Magnetoresistance Effect.

WO 2005/010542 discloses the detection or determination of the presence of magnetic particles using an integrated or on-chip magnetic sensor element. The device may be used for magnetic detection of binding of biological molecules on a micro-array or biochip. Particularly, WO 2005/010542 discloses a magnetic sensor device for determining the presence of at least one magnetic particle and comprises a magnetic sensor element on a substrate, a magnetic field generator for generating an AC magnetic field, a sensor circuit comprising the magnetic sensor element for sensing a magnetic property of the at least one magnetic particle which magnetic property is related to the AC magnetic field, wherein the magnetic field generator is integrated on the substrate and is arranged to operate at a frequency of 100 Hz or above.

WO 2005/010543 discloses a magnetic sensor device comprising a magnetic sensor element on a substrate and at least one magnetic field generator for generating a magnetic field on the substrate, wherein cross-talk suppression means are present for suppressing cross-talk between the magnetic sensor element and the at least one magnetic field generator.

However, cross-talk may still be problematic under undesired circumstances.

### OBJECT AND SUMMARY OF THE INVENTION

It is an object of the invention to provide a sensor with sufficiently small cross-talk.

In order to achieve the object defined above, a magnetic sensor device for sensing magnetic particles, a method of sensing magnetic particles, a program element, and a computer-readable medium according to the independent claims are provided.

According to an exemplary embodiment of the invention, a magnetic sensor device for sensing magnetic particles is provided, the magnetic sensor device comprising a magnetic field generator unit adapted for generating a magnetic field, an excitation signal source adapted for supplying the magnetic field generator unit with a static electric excitation signal, an excitation switch unit adapted for switching between different modes of electrically coupling the excitation signal source to the magnetic field generator unit, and a sensing unit adapted for sensing a signal indicative of the presence of the magnetic particles in the generated magnetic field.

According to another exemplary embodiment of the invention, a method of sensing magnetic particles is provided, the method comprising generating a magnetic field by a magnetic field generator unit, supplying a static electric excitation signal to the magnetic field generator unit, switching between different modes of electrically coupling the magnetic field generator unit with the static electric excitation signal, and sensing, by a sensing unit, a signal indicative of the presence of the magnetic particles in the generated magnetic field.

According to still another exemplary embodiment of the invention, a program element is provided, which, when being executed by a processor, is adapted to control or carry out a method of sensing magnetic particles having the above mentioned features.

According to yet another exemplary embodiment of the invention, a computer-readable medium is provided, in which a computer program is stored which, when being executed by a processor, is adapted to control or carry out a method of sensing magnetic particles having the above mentioned features.

The electronic sensing scheme according to embodiments of the invention can be realized by a computer program, that is by software, or by using one or more special electronic optimization circuits, that is in hardware, or in hybrid form, that is by means of software components and hardware components.

According to an exemplary embodiment, a magnetic sensor is provided which may be realized as a magnetic biosensor IC with cross-talk reduction and sense current interference suppression or removal. In such a magnetic sensor, a magnetic field generator may generate a magnetic field and a sensing unit (for instance a GMR sensor) detects the presence or absence or amount of magnetic particles to be detected in the magnetic field since such magnetic particles may characteristically influence or modify a signal detected by the sensing unit in the magnetic field. Such a magnetic field generator unit may be a wire or a conductor or a coil having two terminals and being supplied with a constant electric excitation signal, for instance a direct current (DC). In order to generate a time dependent signal modulating the magnetic field generator in time, the two terminals of the magnetic field generator may be connected in two different ways to the exciting source so that a polarity or a flowing direction of the current flowing through the magnetic field generator may be varied in time with a frequency defined by an operation frequency of the excitation switch unit. Also the sensing unit may be supplied with a constant drive current which may be switched in a similar manner (for instance with the same switching frequency and/or in synchronization) as the magnetic field generator. Advantageously, the switch sequence of the exciting current flowing direction through the magnetic field generator and of the sensing current flowing direction through the sensing unit may be coordinated with respect to a switching chronology. Such an operation scheme may significantly improve the sensitivity and accuracy of the sensor, since parasitic LC contributions may be suppressed and cross-talk may be avoided.

Therefore, according to an exemplary embodiment, a magnetic sensor device is provided comprising at least one magnetic field generator for generating a magnetic excitation field in distinct investigation regions of a sample chamber and at least one associated magnetic sensor element. Moreover, such a magnetic sensor device may be used for the detection of at least one magnetically interactive particle. Such a sensor may be adapted as a micro-sensor device which may for example be used in a microfluidic biosensor for the detection of biological molecules labeled with magnetic beads.

Next, further exemplary embodiments of the invention will be explained. In the following, further exemplary embodiments of the magnetic sensor device will be explained. However, these embodiments also apply for the method of sensing magnetic particles, for the program element and for the computer-readable medium.

The magnetic sensor device may further comprise a sensing signal source adapted for supplying the sensing unit with a static electric sensing signal. A sensing switch unit may be adapted for switching between different modes for coupling the sensing signal source to the sensing unit. Therefore, also the sensing current generation may be operated in a manner that a time independent source signal may be converted into a time varying signal using a sensing switch which simply couples the constant electric sensing signal (for instance a direct current, DC) to two terminals of a sensing unit so that the flowing direction of the static electric sensing signal through the sensing unit is varied, representing the two different modes of coupling. By taking this measure, particularly in combination with such an operation of the magnetic field generator, it may be possible to modulate the sensor in a way to efficiently suppress cross-talk and remove artefacts from the measurement spectrum.

The magnetic sensor device may further comprise a synchronization unit adapted for synchronizing the excitation switch unit with the sensing switch unit. Particularly, the excitation switch unit and the sensing switch unit may be operable with a common switch frequency (with or without synchronizing). The synchronization unit may be adapted for synchronizing the excitation switch unit with the sensing switch unit by controlling the excitation switch unit and the sensing switch unit using a common switch frequency. By adjusting the performance of the sensing switch unit and of the excitation switch unit, the time dependence of the application of the exciting signal and of the sensing signal may be brought in proper correlation to one another, further increasing the quality of the sensor measurement. For instance, exactly the same switching frequency and switching chronology may be applied for controlling the magnetic field generator unit and the sensing unit.

Particularly, the common switch frequency may be a frequency at which the 1/f noise of the magnetic sensor device essentially equals the thermal white noise. At very low frequencies, the 1/f noise contribution of the sensor dominates over the thermal white noise, which is essentially frequency independent. A proper operation mode of the common switch unit may be a region in which neither the one nor the other noise contribution is significantly dominant. The common switch frequency can be chosen at, for instance, 100 kHz, just outside the 1/f noise spectrum of the GMR. This may provide already a factor of 100 (or 40 dB) less cross-talk voltage than in the case when the frequency (f1 in FIG. 8) is chosen at e.g. 10 MHz because of the required separation for filtering.

The static electric excitation signal and the static electric sensing signal may be Direct Current (DC) signals. In contrast to conventional approaches, in which alternating currents are applied to the magnetic field generator unit and to the sensing unit, embodiments of the invention simply apply a direct current signal having a constant amplitude over time to these units. The switch units may then function as digital switches or as modulators applying this direct current in one half cycle in a first direction to the units, and in another half cycle to the opposite direction.

The different modes of electrically coupling the excitation signal source to the magnetic field generator unit may differ with regard to a flow direction of the static electric excitation signal through the magnetic field generator unit. In other words, one and the same current may be applied to two terminals of the magnetic field generator unit or to the sensing unit in a manner that, in a first half cycle, the current flows from a first terminal to a second terminal, and in a second half cycle, the current flows from the second terminal to the first terminal.

The different modes of electrically coupling the sensing signal source to the sensing unit may differ with regard to a flowing direction of the static electric sensing signal through the sensing unit. What has explained above for the different modes of electrically coupling the excitation signal source to the magnetic field generator unit also holds for the different modes of electrically coupling the sensing signal source to the sensing unit.

The magnetic sensor device may comprise an evaluation unit adapted for electronically evaluating the signal sensed by the sensing unit. The evaluation unit may be an electric circuit which has some processing capabilities so as to process a sensed signal to derive the information whether the magnetic particles to be detected are present or absent, particularly in which concentration or amount they are present. Therefore, such an evaluation unit may allow for quantitative or qualitative evaluation of the measurement result. As a basis for such an evaluation, a sensed signal may be tapped off from the sensing unit, which may be a GMR sensor. The sensing unit can also comprise any suitable sensor based on the detection of the magnetic properties of particles to be measured on or near to the sensor surface. Therefore, the sensor is designable as a coil, magneto-resistive sensor, magneto-restrictive sensor, Hall sensor, planar Hall sensor, flux gate sensor, SQUID (Semiconductor Superconducting Quantum Interference Device), magnetic resonance sensor, or as another sensor actuated by a magnetic field.

The evaluation unit may comprise an amplifier for amplifying the signal sensed by the sensing unit. Such an amplifier may be useful to increase the amplitude of the sensed signal, in which the disturbing influences of cross-talk or parasitic capacitances and inductances are already suppressed.

The evaluation unit may comprise an evaluation switch unit for selectively coupling or decoupling the signal sensed by the sensing unit for evaluation. Also the evaluation switch unit may be synchronized with the excitation switch unit and with the sensing switch unit. By coordinating the switching frequencies of the described three switching units, a desirable coordination of their function may be obtained, increasing the sensitivity of the sensor.

The evaluation switch unit, the excitation switch unit, and the sensing switch unit may comprise a CMOS chopper circuit. Such a CMOS chopper unit may be a low cost implementation of the switching circuitry, with proper accuracy.

The evaluation unit may comprise a signal evaluation delay unit for delaying the signal evaluation by a predetermined time delay value after a switch performed by at least one of the group consisting of the excitation switch unit and the sensing switch unit has occurred. After such a switch, the measurement spectrum may include peaks or spikes as artefacts so that it may be recommendable to wait for a predetermined waiting time until the actual evaluation is started. By such a delay or selection of a (delayed) time interval for evaluating a measurement spectrum, more meaningful results may be obtained.

The signal evaluation delay unit may comprise at least one of the group consisting of a sample and hold analog to digital converter, a high speed analog to digital converter, a chopper unit, and a sigma delta converter. Such a built-in time windowing may provide room for the interference spikes to settle down before signal conversion. Thus, such a signal may then be converted to the digital domain by a sample and hold AD converter, a high speed AD converter with throwing away or averaging of the samples, a chopper with guard time, a sigma delta converter that is switched on after guard time, etc.

The sensing unit may be adapted for sensing the magnetic particles by evaluating the signals sensed in the different modes of coupling the sensing signal source to the sensing unit in combination, thereby suppressing at least one of the group consisting of inductive cross-talk and capacitive cross-talk. By the cooperation and coordination of the operation of the sensing unit and the operation of the magnetic field generator, the described disturbing influences may be efficiently suppressed, improving performance of the sensor.

The sensing unit may be adapted for sensing the magnetic particles based on the Giant Magnetoresistance Effect (GMR). Magnetic biosensors may use the Giant Magnetoresistance Effect (GMR) being a quantum mechanical effect observed in thin film structures composed of alternating ferromagnetic and nonmagnetic metal layers. The effect manifests itself as a significant decrease in resistance from the zero-field state, when the magnetization of adjacent (ferro)magnetic layers are antiparallel due to a weak anti-ferromagnetic coupling between layers, to a lower level of resistance when the magnetization of the adjacent layers align due to an applied external field. General aspects of how to realize such a GMR sensor may be taken from WO 2005/010542 A2 and WO 2005/010543 A1, which are herein incorporated by reference in their entirety, in particular with respect to all aspects related to GMR magnetic sensors, particularly biosensors.

The sensing unit may be adapted for quantitatively sensing the magnetic particles. Therefore, the evaluation unit may evaluate amplitudes of the signals in such a manner that as a final result, a concentration or amount of magnetic particles or of magnetically labeled particles to be detected may be estimated. This may be a more meaningful result as compared to a purely qualitative result whether a particular species or fraction of (biological) molecules is present or absent.

The magnetic sensor device may be adapted for sensing magnetic beads attached to biological molecules. Therefore, for instance using linker molecules, paramagnetic or ferromagnetic beads may be attached directly to biological molecules (like nucleic acids, DNA strands, proteins, polypeptides, hormones, etc.) so as to allow or promote a magnetic detection. However, it is possible that magnetic properties of the biological molecules themselves are used as a basis for the detection, without magnetic labels.

Particularly, the magnetic sensor device may be adapted as a magnetic biosensor device, that is to say for detecting the presence or absence or concentration of biological molecules.

At least a part of the magnetic sensor device may be realized as a monolithically integrated circuit. Thus, at least a part of the components of the magnetic sensor device may be monolithically integrated within a substrate, particularly a semiconductor substrate, more particularly a silicon substrate. However, embodiments of the invention may be also applied in a context of group III-V semiconductors, like gallium arsenide. Such a monolithically integration may significantly reduce the dimensions of the biosensor and therefore the required volumes of a sample to be analyzed. Furthermore, the signal processing paths are short and small in an integrated solution, so that the length of a conduction path along which the signals may be negatively influenced by disturbing effects may be reduced. Therefore, such a monolithically integrated biosensor may be particularly advantageous.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a magnetic sensor device according to an exemplary embodiment in a first operation state.

FIG. 2 illustrates the magnetic sensor device of FIG. 1 in a second operation state.

FIG. 3 illustrates a magnetic sensor device according to an exemplary embodiment of the invention.

FIG. 4 to FIG. 7 show magnetic sensor devices to illustrate a corresponding noise behavior.

FIG. 8 to FIG. 10 illustrate magnetic sensor devices according to exemplary embodiments of the invention.

FIG. 11 to FIG. 14 illustrate inductive cross-talk reduction according to exemplary embodiments of the invention.

FIG. 15 and FIG. 16 illustrate capacitive cross-talk reduction according to exemplary embodiments of the invention.

FIG. 17 and FIG. 18 illustrate a magnetic sensor device implementing single frequency detection according to an exemplary embodiment of the invention.

FIG. 19 and FIG. 20 illustrate a magnetic sensor device implementing time windowing according to an exemplary embodiment of the invention.

FIG. 21 illustrates a magnetic sensor device including a chopper multiplexing functionality according to an exemplary embodiment of the invention.

### DESCRIPTION OF EMBODIMENTS

The illustration in the drawing is schematically. In different drawings, similar or identical elements are provided with the same reference signs.

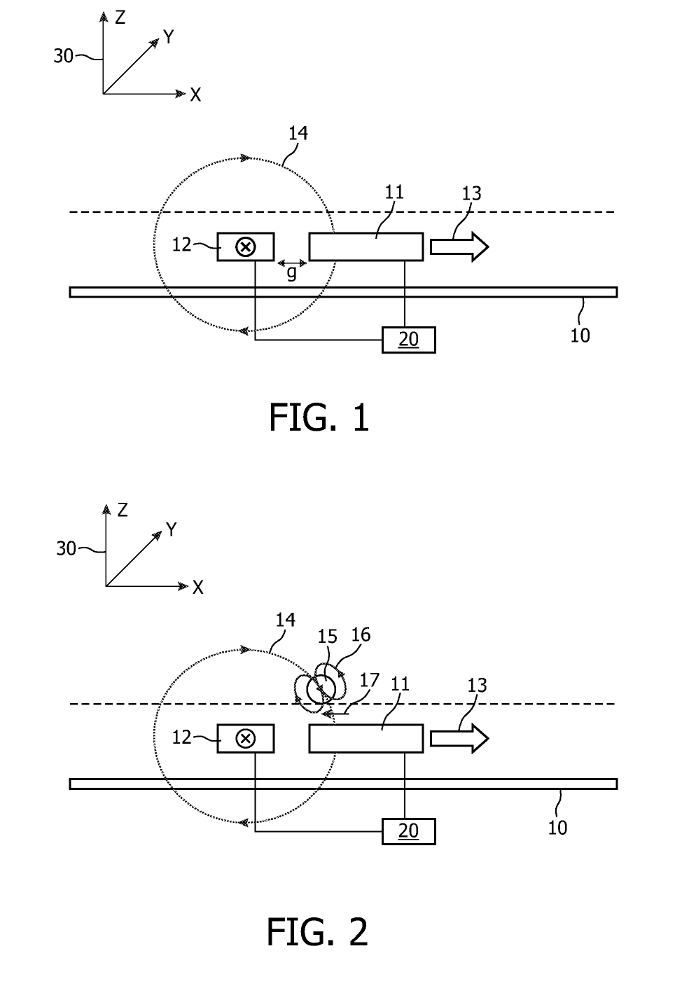

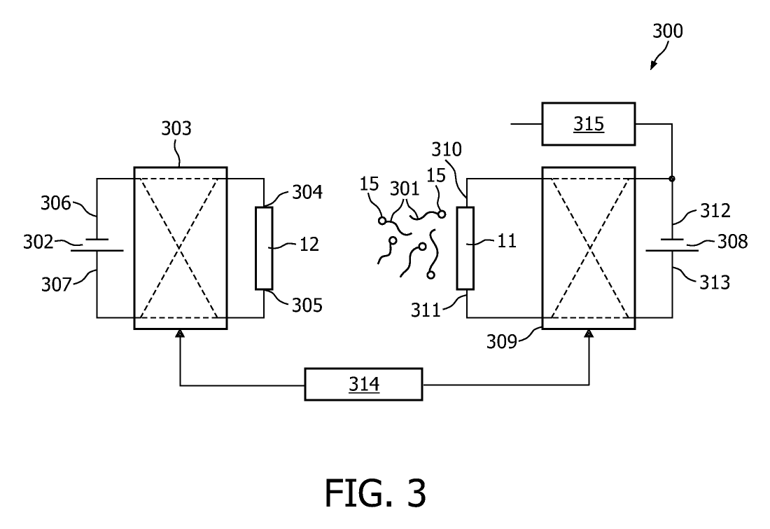

In a first embodiment the device according to the present invention is a biosensor and will be described with respect to FIG. 1 and FIG. 2. The biosensor detects magnetic particles in a sample such as a fluid, a liquid, a gas, a visco-elastic medium, a gel or a tissue sample. The magnetic particles can have small dimensions. With nano-particles are meant particles having at least one dimension ranging between 0.1 nm and 1000 nm, preferably between 3 nm and 500 nm, more preferred between 10 nm and 300 nm. The magnetic particles can acquire a magnetic moment due to an applied magnetic field (e.g. they can be paramagnetic). The magnetic particles can be a composite, e.g. consist of one or more small magnetic particles inside or attached to a non-magnetic material. As long as the particles generate a non-zero response to a modulated magnetic field, i.e. when they generate a magnetic susceptibility or permeability, they can be used.

The device may comprise a substrate 10 and a circuit e.g. an integrated circuit.

A measurement surface of the device is represented by the dotted line in FIG. 1 and FIG. 2. In embodiments of the present invention, the term “substrate” may include any underlying material or materials that may be used, or upon which a device, a circuit or an epitaxial layer may be formed. In other alternative embodiments, this “substrate” may include a semiconductor substrate such as e.g. a doped silicon, a gallium arsenide (GaAs), a gallium arsenide phosphide (GaAsP), an indium phosphide (InP), a germanium (Ge), or a silicon germanium (SiGe) substrate. The “substrate” may include for example, an insulating layer such as a Si0₂ or an Si₃N₄ layer in addition to a semiconductor substrate portion. Thus, the term substrate also includes glass, plastic, ceramic, silicon-on-glass, silicon-on sapphire substrates. The term “substrate” is thus used to define generally the elements for layers that underlie a layer or portions of interest. Also, the “substrate” may be any other base on which a layer is formed, for example a glass or metal layer. In the following reference will be made to silicon processing as silicon semiconductors are commonly used, but the skilled person will appreciate that the present invention may be implemented based on other semiconductor material device(s) and that the skilled person can select suitable materials as equivalents of the dielectric and conductive materials described below.

The circuit may comprise a magneto-resistive sensor 11 as a sensor element and a magnetic field generator in the form of a conductor 12. The magneto-resistive sensor 11 may, for example, be a GMR or a TMR type sensor. The magneto-resistive sensor 11 may for example have an elongated, e.g. a long and narrow stripe geometry but is not limited to this geometry. Sensor 11 and conductor 12 may be positioned adjacent to each other within a close distance g. The distance g between sensor 11 and conductor 12 may for example be between 1 nm and 1 mm; e.g. 3 μm. The minimum distance is determined by the IC process.

In FIG. 1 and FIG. 2, a co-ordinate device is introduced to indicate that if the sensor device is positioned in the xy plane, the sensor 11 mainly detects the x-component of a magnetic field, i.e. the x-direction is the sensitive direction of the sensor 11. The arrow 13 in FIG. 1 and FIG. 2 indicates the sensitive x-direction of the magneto-resistive sensor 11 according to the present invention. Because the sensor 11 is hardly sensitive in a direction perpendicular to the plane of the sensor device, in the drawing the vertical direction or z-direction, a magnetic field 14, caused by a current flowing through the conductor 12, is not detected by the sensor 11 in absence of magnetic nano-particles 15. By applying a current to the conductor 12 in the absence of magnetic nano-particles 15, the sensor 11 signal may be calibrated. This calibration is preferably performed prior to any measurement.

When a magnetic material (this can e.g. be a magnetic ion, molecule, nano-particle 15, a solid material or a fluid with magnetic components) is in the neighborhood of the conductor 12, it develops a magnetic moment m indicated by the field lines 16 in FIG. 2.

The magnetic moment m then generates dipolar stray fields, which have in-plane magnetic field components 17 at the location of the sensor 11. Thus, the nano-particle 15 deflects the magnetic field 14 into the sensitive x-direction of the sensor 11 indicated by arrow 13 (FIG. 2). The x-component of the magnetic field Hx which is in the sensitive x-direction of the 12 sensor 11, is sensed by the sensor 11 and depends on the number of magnetic nano-particles 15 and the conductor current Ic.

For further details of the general structure of such sensors, reference is made to WO 2005/010542 and WO 2005/010543.

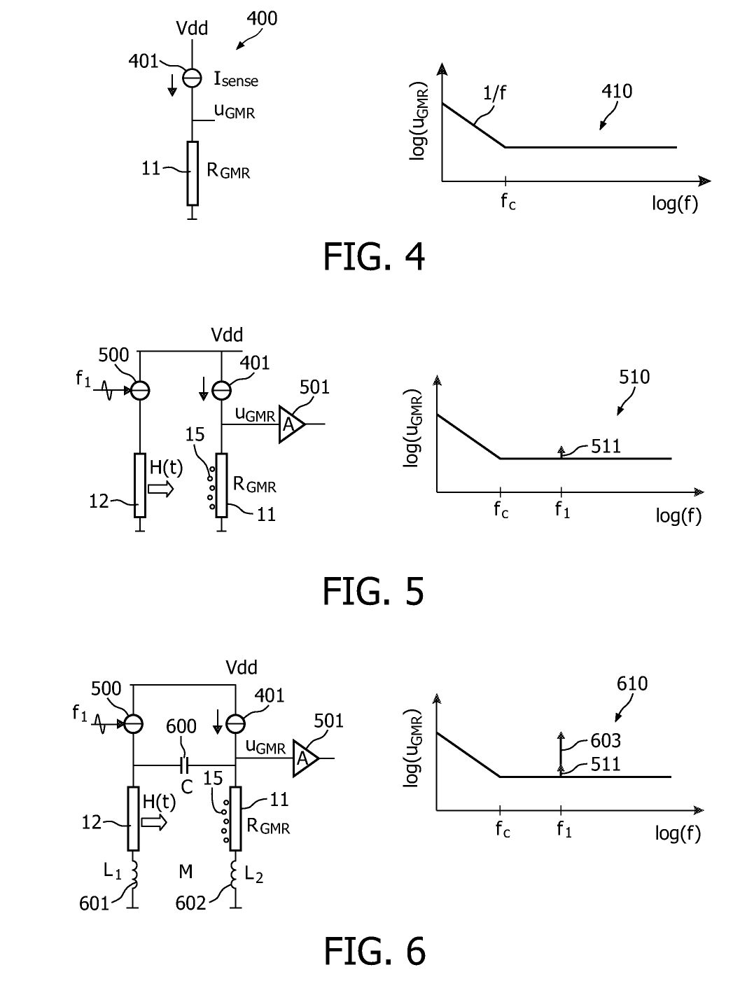

Reference numeral 20 in FIG. 1 and FIG. 2 illustrates a control unit coordinating the operation mode of the sensing unit 11 and of the magnetic field generator 12. Embodiments for such a control entity 20 will be explained below referring to FIGS. 3, 8 to 21.

In the following, referring to FIG. 3, a magnetic sensor device 300 according to an exemplary embodiment of the invention will be explained.

The magnetic sensor device 300 is adapted for sensing magnetic particles 15 which are attached to biologic molecules 301 to be detected. For instance, the biologic molecules 301 are DNA strands having a portion at which the magnetic beads 15 are attached. Furthermore, the magnetic field generator unit 12 is shown which is adapted for generating a magnetic field 14. Beyond this, an excitation signal source 302, namely a first direct current (DC) source, is provided for supplying the magnetic field generator unit 12 with a static electric excitation signal, namely a direct current.

An excitation switch unit 303 is provided for switching between different modes of electrically coupling the excitation signal source 302 to the magnetic field generator unit 12. As can be taken from FIG. 3, the magnetic field generator unit 12 comprises a first terminal 304 and a second terminal 305. The excitation signal source 302 comprises a first terminal 306 and a second terminal 307. The excitation switch unit 303 couples the excitation signal source 302 to the magnetic field generator unit 12 so that, in a first half cycle of a period, the first terminal 304 of the magnetic field generator unit 12 is coupled to the first terminal 306 of the excitation switch unit 306, and the second terminal 305 of the magnetic field generator unit 12 is coupled to the second terminal 307 of the excitation signal source 302. In a second half cycle, the excitation switch unit 302 switches the connections between the terminals 304 to 307 so that, in the second half cycle, the first terminal 304 of the magnetic field generator 12 is coupled to the second terminal 307 of the excitation signal source 302 and the second terminal 305 of the magnetic field generator 12 is coupled to the first terminal 306 of the excitation signal source 302.

Beyond this, the magnetic sensor device 300 comprises a sensing unit 11 (a GMR sensor) for sensing a signal indicative of the presence of the magnetic particles 15 in the generated magnetic fields. A sensing signal source 308 is provided as a further direct current (DC) source and is adapted for supplying the sensing unit 11 with a static electric sensing signal, namely with a further direct current. A sensing switch unit 309 is provided and is adapted for switching between different modes of coupling the sensing signal source 308 to the sensing unit 11. Particularly, the sensing unit 11 has a first terminal 310 and has a second terminal 311, and the sensing signal source 308 has a first terminal 312 and a second terminal 313. In a first half cycle of a period, the switching unit 309 couples the sensing unit 11 to the sensing signal source 308 so that the first terminal 310 is coupled to the first terminal 312 and the second terminal 311 is coupled to the second terminal 313. In a second half cycle, the first terminal 310 is coupled with the second terminal 313 and the second terminal 311 is coupled to the first terminal 312.

Furthermore, a synchronization unit 314 is provided which synchronizes the actuation of the excitation switch unit 303 and the sensing switch unit 309 so that the switches occur simultaneously. Furthermore, the synchronization unit 314 steers the switching units 303 and 309 to have the same switch frequency.

Beyond this, an evaluation unit 315 is foreseen for electrically evaluating a signal sensed by the sensing unit 11. Therefore, the signal to be analyzed is tapped off at one of the terminals 312 or 313 of the sensing unit 11. The evaluation unit 315 may include components like an amplifier, an analog to digital converter, filters, etc. The evaluation unit 315 may evaluate the detected signals in the two operation modes defined by the switch units 303 and 309.

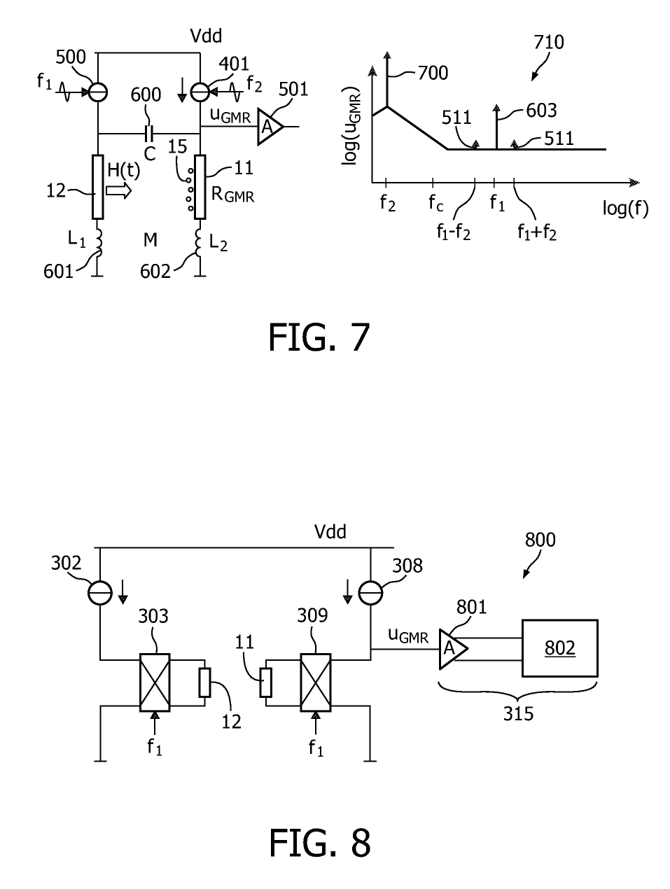

In the following, referring to FIG. 4 to FIG. 7, problems will be explained which may occur in magnetic sensor devices.

Electronic errors that may be introduced in a micro sensor system can in general be classified in three groups: random, systematic and multipath errors. The largest source of random errors in GMR based biosensors is the intrinsic 1/f noise of the GMR.

The GMR 11 is shown in FIG. 4 and may be conventionally driven with a sense circuit Iₛₑₙₛₑ 401. As can be taken from a diagram 410, at very low frequencies, the 1/f noise is dominant, whereas at higher frequency values the white noise which is in essentially constant becomes dominant.

In order to avoid this noise spectrum and to allow the signal-to-noise ratio to be determined by the thermal noise floor of the sensor element alone, it is possible to modulate up the excitation current in the frequency spectrum, above the 1/f noise corner frequency f_{c} of the GMR.

Such a scenario is shown in FIG. 5.

FIG. 5 illustrates an excitation current source 500 and the sense current source 401. An amplifier 501 may evaluate the result. As can be taken from a diagram 510, by using an operation frequency f₁>f_{c}, the magnetic sensing contribution 511 may be better separable from the noise contribution. The high frequency magnetic field H(t) produced by the up-modulated excitation current causes the sensor resistance value R_{GMR} to vary in time with frequency f₁, having a magnitude \hat{r} that is dependent on the amount of super-paramagnetic nanoparticles (i.e. beads 15) near the sensor 11.

Hᵢₙ₋ₚₗₐₙₑ(t)∞sin(2πf₁t)

R_{GMR}=R+ΔR(t)=R+s_{GMR}·Hᵢₙ₋ₚₗₐₙₑ(t)=R+\hat{r}sin(2πf₁t)

where s_{GMR} is the GMR sensitivity in (ΩmA⁻¹) and Hᵢₙ₋ₚₗₐₙₑ(t) is the in-plane component of the stray magnetic field originating from the beads 15, in units of (Am⁻¹).

Due to unavoidable capacitive and inductive coupling (symbolized in FIG. 6 with a parasitic capacitance 600 and with parasitic inductances 601, 602), an LC cross-talk interference is coupled from the current wire to the sensor 11. Typically, this cross-talk component 603 which is shown in a diagram 610 of FIG. 6 is 10.000 times bigger than the magnetic sensor signal 511, which results into a large dynamic range at frequency f₁.

Although the LC cross-talk voltage is 90° phase shifted with respect to the magnetic signal 511 and is in principle a systematic error, the aforementioned dynamic range makes detection at f₁ difficult to realize.

In order to circumvent this problem, as shown in FIG. 7, the magnetic signal 511 may be separated in the frequency domain from the LC cross-talk component 603 by application of electronic sensed current modulation at a second frequency f₂.

A diagram 710 in FIG. 7 illustrates the sensed current 700. The signal separation occurs within the GMR element 11 as a result of Ohm's Law; the magnetic signal spectral components appear at the sum and difference of the frequencies f₁ and f₂.

$$\begin{matrix}{u}_{GMR} = {I}_{sense} \cdot {R}_{GMR} \\ = {\hat{i}}_{sense} sin ( 2 π {f}_{2} t ) \cdot ( R + \hat{r} sin ( 2 π {f}_{1} t ) ) \\ = \underbrace{R {\hat{i}}_{sense} sin ( 2 π {f}_{2} t )}_{Sense - current component} + \\ \underbrace{\frac{{\hat{i}}_{sense} \hat{r}}{2} ( cos ( 2 π ( {f}_{1} + {f}_{2} ) t ) + cos ( 2 π ( {f}_{1 -} {f}_{2} ) t ) )}_{Magnetic signal}\end{matrix}$$

The 1/f noise spectrum is also modulated around f₂ as the underlying resistance-value fluctuations have been (experimentally) shown to possess the magnetic origin.

In the light of the foregoing, there may be the problem that the electronic modulation of the sense-current introduces a large interference signal at f₂ 700 that can easily force the pre-amplifier A 501 into saturation. The intermodulation and distortion products that are then generated interfere severely with a measurement.

To avoid this, a rejection of the sense-current component may be required by, for instance, filtering in the frequency domain.

However, this measure requires on-chip high pass filtering that significantly increases the integrated circuit area and complexity. In particular, the following extra arrangements are required: a means for modulation of the sense-current, a second frequency in a system, and a high pass filter.

Especially the high pass filter may be difficult to integrate, and it may require a large area for the coupling capacitances in a high bandwidth pre-amplifier A 501. The latter is because the sense-current interference at f₂ may be one million times bigger than the wanted magnetic signal at f₁±f₂. In order to obtain enough suppression of the f₂ component with a simple (for instance first order) filter, large f₁ and f₂ frequency separation is required.

Based on these recognitions, exemplary embodiments of the invention provide an uncomplicated architecture and elements for a single frequency measurement that avoids the need for an on-chip high pass filtering.

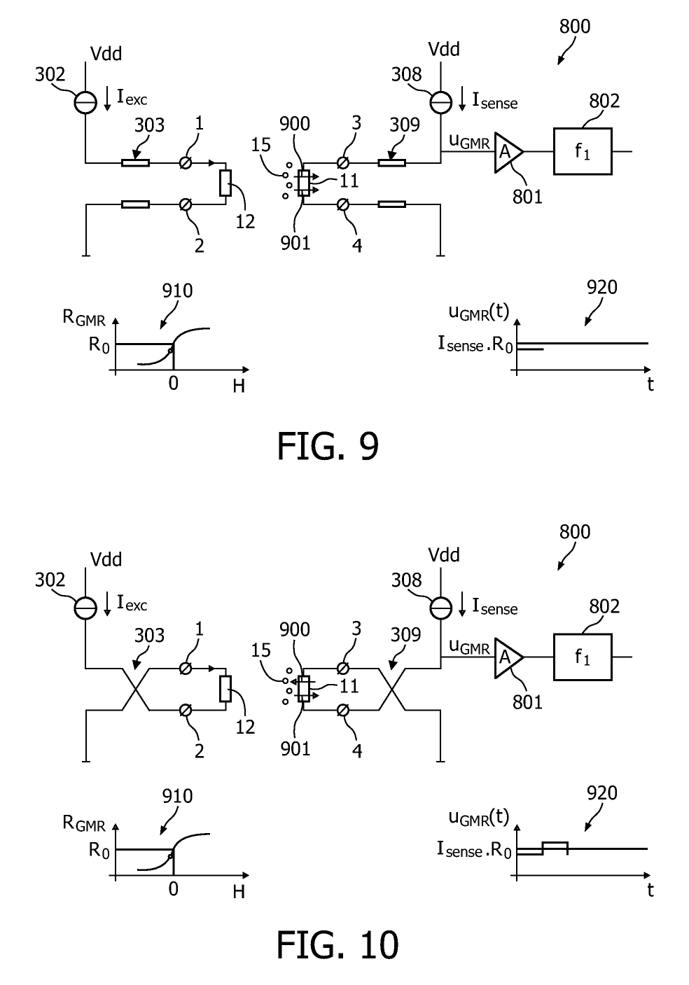

A solution according to an exemplary embodiment of the invention is shown in FIG. 8 and will be explained in the following.

In addition to the already described components, the magnetic sensor device 800 shown in FIG. 8 shows an evaluation unit 315 which comprises an amplifier 801 and a signal processing block 802.

By making the excitation and sense-current substantially equal and static with respect to each other, the capacitive and inductive cross-talk component can be significantly reduced.

According to an exemplary embodiment, the signal voltage is sensed at the opposite side of the switching circuitry than at which the magnetic sensor is connected. This may reduce or eliminate the LC cross-talk at the frequency of interest by transposing its energy to DC and even harmonics. Furthermore, the sense-current interference is suppressed or can be even completely removed with a result that on-chip high pass filtering is not required any longer.

In the following, referring to FIG. 9 and FIG. 10, such an embodiment will be explained in more detail.

Next, characteristics of the magnetic signal will be discussed.

A DC excitation current source 302 feeds a current to the field generating wire 12 first through a terminal 1 (the first terminal 304 of FIG. 3) during one part of the period. This first phase is shown in FIG. 9.

Simultaneously, a DC sense current source 308 feeds the current to the GMR sensor 11 through a terminal 3 (first terminal 310 in FIG. 3).

A stray magnetic field originating from the magnetic beads 15 causes the magnetization of a free layer 900 to align parallel to a pinned layer 901, with a magnitude that is proportional to the amount of the beads 15 near the sensor 11. The parallel alignment will cause the GMR resistance to be lower than the zero field resistance R₀.

The voltage u_{GMR}(t) that is applied to the pre-amplifier 801 is during this phase lower than the DC value IₛₑₙₛₑR₀.

FIG. 9 also shows a diagram 910 illustrating the field H dependence of the resistance R_{GMR} and a second diagram 920 illustrating the dependence of the voltage u_{GMR}(t) of the time t.

The block 802 performs a detection at the frequency f₁.

All voltages are referenced to ground. For example, u_{GMR}(t) is a voltage from node u_{GMR} to the ground node.

The second part of the period is shown in FIG. 10.

In this operation state, the excitation current is reversed, causing the free layer 900 to align antiparallel to the pinned layer 901. The aforementioned currents are now fed through terminals 2 and 4, respectively (corresponding to the second terminals 305 and 311 in FIG. 3). The antiparallel orientation increases the GMR resistance, such that during this phase the voltage u_{GMR}(t) assumes a larger value than the DC value IₛₑₙₛₑR₀.

Accordingly, the voltage u_{GMR}(t) that is applied to the pre-amplifier 801 varies in time with frequency f₁ and has a magnitude that is a measure for the amount of the magnetic beads 15 near the sensor 11.

In the following, it will be shown that the synchronous reversal of the terminals 3 and 4 removes or at least significantly suppresses the LC cross-talk voltage from frequency f₁ at the node u_{GMR}, at which the magnetic signal is sensed.

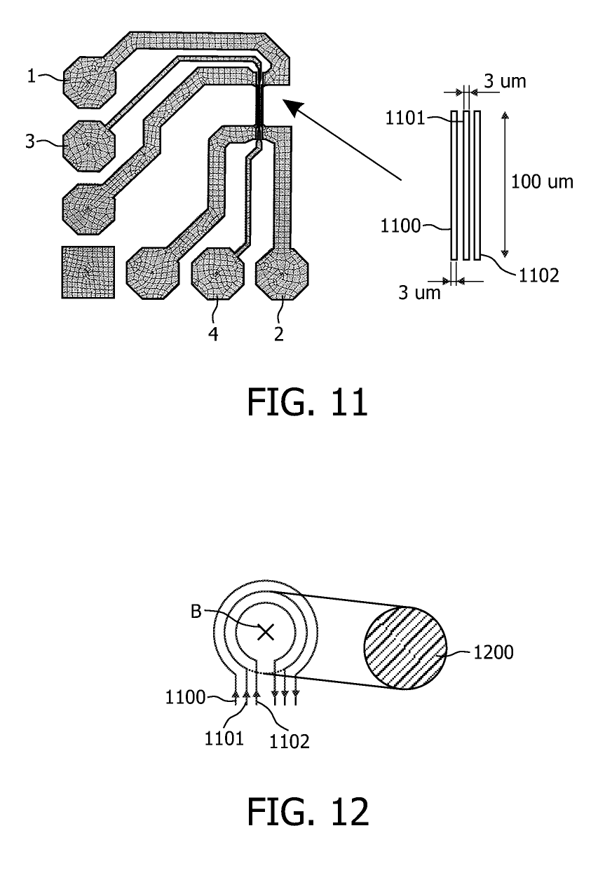

In the following, referring to FIG. 11 to FIG. 14, inductive cross-talk reduction will be explained.

In many sensor geometries, the inductive cross-talk component has the largest contribution and may be several orders of magnitude larger than the capacitive cross-talk, and up to 10.000 times larger than the magnetic signal. Therefore, it may be important to remove this inductive cross-talk component, which may be at the same frequency f₁ as the wanted magnetic signal.

One sensor layout is illustrated in FIG. 11.

FIG. 11 shows the terminals 1 to 4 and, in an enlarged view, a configuration of wires 1100, 1102 and of a GMR element 1101 located between the wires 1100 and 1102.

The arrangement can be approximated by three concentric coplanar loops as shown in FIG. 11.

The time varying magnetic flux density, B, generated by a reversing current through the field generating wire induces a cross-talk voltage across the GMR terminals, which may be proportional to the surface A.

FIG. 12 again shows such a configuration with the field generating wires 1100, 1102, and the GMR element 1101. Furthermore, the surface A is denoted with reference numeral 1200.

The momentary cross-talk voltage induces across the GMR terminals can be written as

$$\begin{matrix}e ( t ) = - \frac{\partial }{\partial t} {\int }_{S} \vec{B} \cdot d \vec{a} \\ = - M \frac{d I}{d t}\end{matrix}$$

where M is the mutual inductance between a field generating wire 1100, 1102 and the GMR element 1101. The mutual inductance M depends only on geometrical factors and is time-independent.

The cross-talk voltage is induced primarily around the excitation current rise and fall transitions, denoted with Δtᵣ and Δt_{f}, respectively, in the diagram 1300 shown in FIG. 13.

Circuit diagrams 1310 and 1320 of FIG. 13 show schematically that during the rise transition the voltage e will have a certain sine (for instance positive) and the voltage at the pre-amplifier node u_{GMR} will also be positive.

During the fall transition, the sine of the voltage e will reverse (for instance negative), whereas the voltage at the node u_{GMR} will remain positive as a result of the synchronous sensor polarity reversal.

The induced cross-talk voltage across the GMR terminals, e(t), and at the pre-amplifier input, u_{GMR}(t), will have a similar shape as sketched in diagrams 1400 and 1410 of FIG. 14.

The diagram 1400 shows the situation without synchronous reversal, and the diagram 1410 shows the situation with synchronous reversal. Therefore, diagram 1410 shows that the most energy of the inductive cross-talk is moved from f₁ to DC and to double frequency 2f₁.

The self-induced voltage due to L diₛₑₙₛₑ/dt is also removed from f₁ by the synchronous reversal of the sensor polarity. However, the magnitude of the aforementioned component is several orders of magnitude lower than the induced voltage from the excitation current and may be neglected.

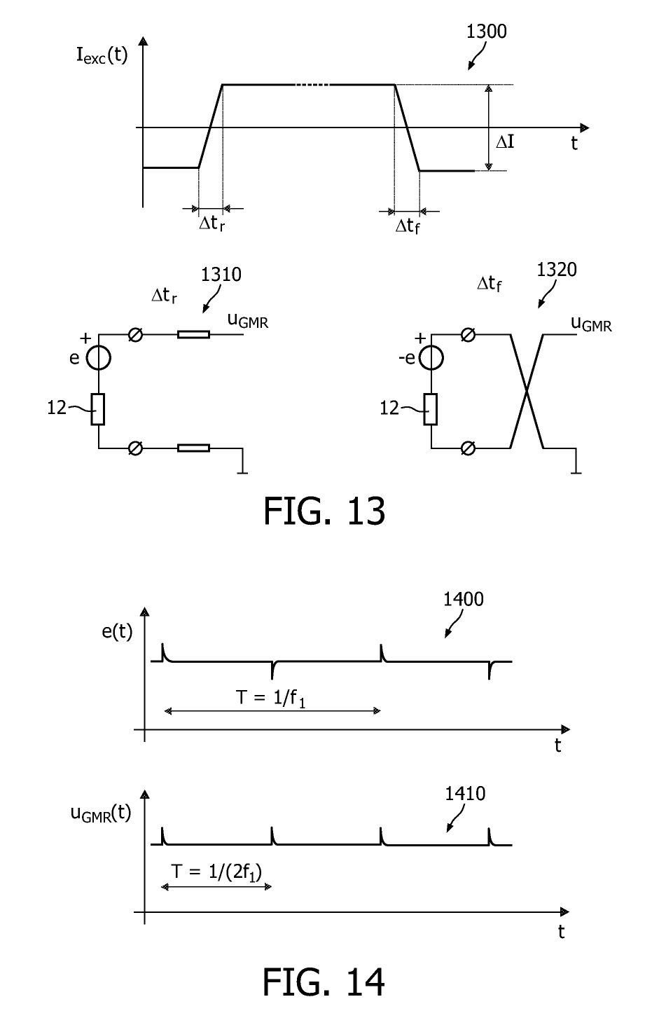

In the following, referring to FIG. 15 and FIG. 16, the capacitive cross-talk reduction will be explained.

The capacitive cross-talk voltage is removed from f₁ primarily by the same modulation principle that removes the inductive cross-talk, as explained above. However, an extra mechanism can simultaneously be deployed to reduce the amount of induced capacitive cross-talk in the first place, before being modulated away from f₁.

Considering FIG. 15, a DC excitation current source 302 feeds a current to the field generating wire 12 through a first terminal 1 during one part of the period (this “first phase” is shown in FIG. 15). Simultaneously, a DC sense current source 308 feeds a current to the GMR sensor 11 through terminal 3.

The corresponding voltages at terminals 1, 2, 3 and 4 (namely V₁(t) through V₄(t)), are also shown in diagrams 1500, 1510, 1520, 1530, respectively.

In the second part of the period, the so-called “phase two” which is shown in FIG. 16, the direction of current flow through the field generating wire 12 and the GMR sensor 11 is reversed. The aforementioned currents are now fed through terminals 2 and 4, respectively.

The resulting terminal voltage is shown in diagrams 1500, 1510, 1520, 1530 of FIG. 16.

The capacitive cross-talk reduction is based on the knowledge that the amplitude of a cross-talk voltage is proportional to the displacement current through the parasitic capacitances Cₚₐᵣ₁ and Cₚₐᵣ₂ (reference numerals 1501 and 1502). This is achieved by the simultaneous reversal of the sense and excitation currents (making them time-invariant with respect to each other), and by making the magnitude of the electric potential at nodes 1 and 3 substantially equal (reducing the charge storage and the capacitances).

For example,

V₁=I_{exc}*R_{wire}=100 mA*10Ω=1 V

V₃=Iₛₑₙₛₑ*R_{GMR}=2 mA*500Ω=1 V

Facilitated by the symmetry of the switching circuitry, the voltages at terminals 2 and 4 are also made substantially equal.

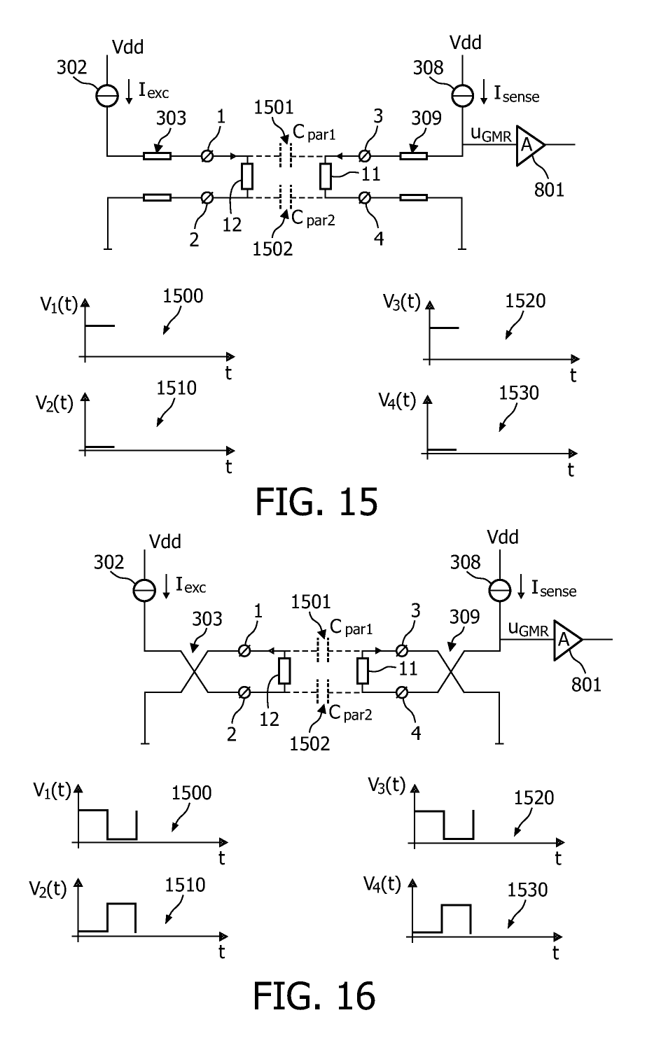

In the following, referring to FIG. 17 and FIG. 18, an embodiment of a magnetic sensor device 1700 with a single frequency detection will be explained.

In the embodiment of the magnetic sensor device 1700 of FIG. 17, a low noise DC excitation current source 302 feeds a current through a switching circuitry 303 to a field generating wire 12, and a second low noise DC sense current source 308 feeds a current to a GMR sensor 11. A first amplifier A₁ 801, which is connected at the node u_{GMR} between the sense current source 308 and the switching circuit 309, senses the signal voltage. The amplified signal is passed on for further signal conditioning to a demodulation unit 1701, an amplification unit A₂ 1702, and an analog to digital conversion unit 1703. Further components may be foreseen.

The switching circuitry 303, 309 is synchronously operated at frequency f₁, at which frequency the magnetic signal is also obtained.

FIG. 18 shows a first diagram 1800 and a second diagram 1810 showing a cross-talk spike spectrum across the GMR terminals, and at the node u_{GMR}.

At the node u_{GMR}, the energy of the spike signal is moved by the switching circuitry to DC and even harmonics of f₁.

A CMOS chopper circuit may low cost implement the switching circuitry 303, 309.

The embodiment of FIG. 17 and FIG. 18 may have the advantage that no on-chip filtering is required. The front end architecture is transparent for a wide range of frequencies (because of no fixed filter time constants). The frequency f₁ can be chosen at, for instance, 100 kHz, just outside the 1/f noise spectrum of the GMR. This will provide already a factor 100 (or 40 dB) less cross-talk voltage than in the case when f₁ is chosen at, for instance, 10 MHz because of the required separation for filtering (with f₂ at for instance 10 kHz).

This embodiment may also provide a possibility for utilization of the GMR DC voltage level for establishing a bias point for the first amplifier 801.

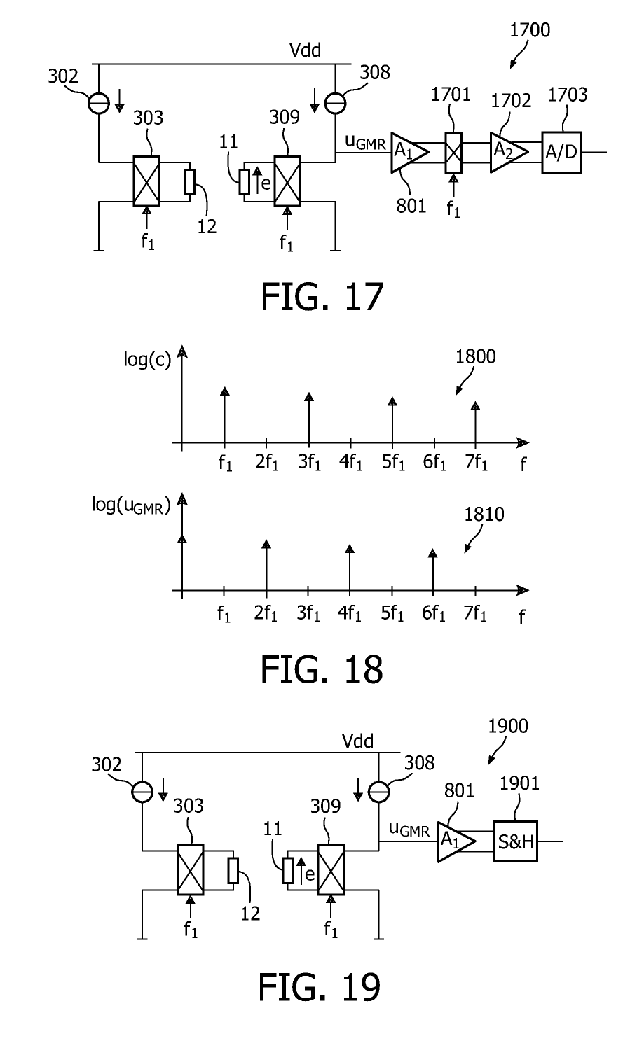

In the following, referring to FIG. 19 and FIG. 20, a magnetic sensor device 1900 according to an exemplary embodiment of the invention will be explained, which has implemented a time windowing feature.

In the embodiment of FIG. 19, time windowing is built in that provides room for the interference spikes to settle down before signal conversion, for instance after 3τ. The signal is then converted to a digital domain by, for instance, a sample and hold converter 1901. Other possibilities are a high speed A/D converter with throwing away of the samples, a chopper with guard time, a sigma delta converter that is switched on after guard time, or any other configuration.

FIG. 20 shows a diagram 2000 also indicating the guard time 2001. Thus, FIG. 20 shows an example of the sampling timing. The signal is sampled after the disturbance due to switching has died out (to a sufficient degree).

This may have the advantage that no demodulation is necessary, which may reduce the amount of hardware and its complexity. Furthermore, the sampler can easily be synchronized with the sampled signal.

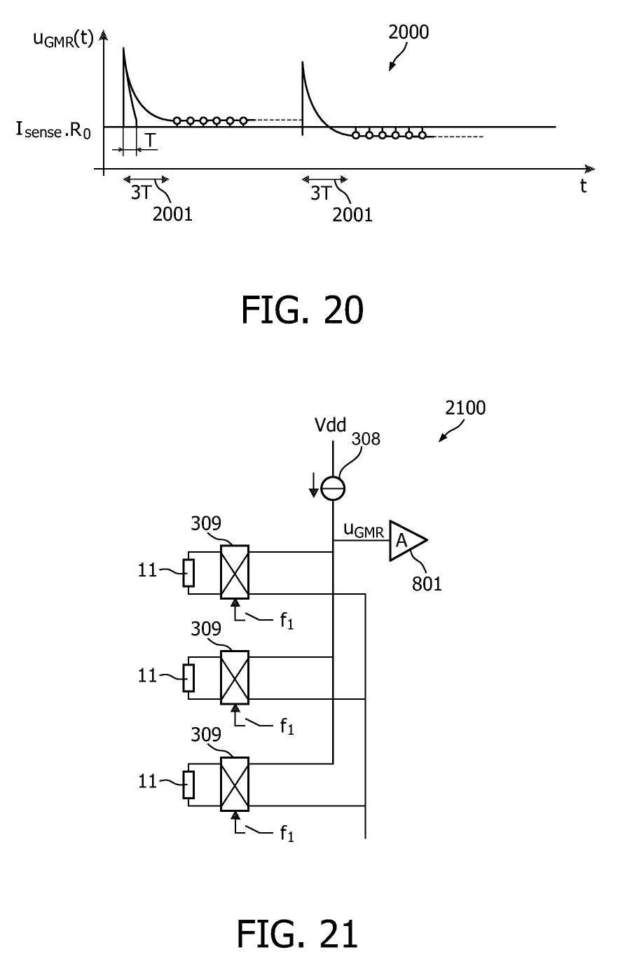

In the following, referring to FIG. 21, a magnetic sensor device 2100 according to an exemplary embodiment of the invention will be explained.

The embodiment of FIG. 21 may be denoted as a “choppermux” embodiment.

In this embodiment, multiplexing functionality is combined with switching circuitry. By applying the switching phases only to one chopper 309 at the time, the required GMR 11 can be selected.

The same principle can be applied for multiplexing of the excitation current source to different field generating wires (not shown in the figures).

Such an embodiment may have the advantage that it requires only one sense current source and one pre-amplifier for multiple GMR sensors. The otherwise required multiplexer switches may now be removed from the signal path, which may improve the noise performance and bandwidth of the circuit.

Precautions should be taken to reduce the amount of clock interference coupling by, for instance, designing the circuits for good PSRR (Power Supply Rejection Ratio) and CMRR (Common Mode Rejection Ratio) performance, applying guard rings, applying common mode and differential mode signal separations, etc.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A magnetic sensor device (300) for sensing magnetic particles (15), the magnetic sensor device (300) comprising
a magnetic field generator unit (12) adapted for generating a magnetic field;
an excitation signal source (302) adapted for supplying the magnetic field generator unit (12) with a static electric excitation signal;
an excitation switch unit (303) adapted for switching between different modes of electrically coupling the excitation signal source (302) to the magnetic field generator unit (12);
a sensing unit (11) adapted for sensing a signal indicative of the presence of the magnetic particles (15) in the generated magnetic field.

2. The magnetic sensor device (300) of claim 1,
further comprising
a sensing signal source (308) adapted for supplying the sensing unit (11) with a static electric sensing signal;
a sensing switch unit (309) adapted for switching between different modes of coupling the sensing signal source to the sensing unit (11).

3. The magnetic sensor device (300) of claim 2,
comprising a synchronization unit (314) adapted for synchronizing the excitation switch unit (303) with the sensing switch unit (309).

4. The magnetic sensor device (300) of claim 2,
wherein the excitation switch unit (303) and the sensing switch unit (309) are operable with a common switch frequency.

5. The magnetic sensor device (300) of claim 4,
wherein the common switch frequency is a frequency at which the 1/f noise of the magnetic sensor device (300) essentially equals the thermal white noise.

6. The magnetic sensor device (300) of claim 4,
wherein the common switch frequency is essentially 100 kHz.

7. The magnetic sensor device (300) of claim 2,
wherein the static electric excitation signal and the static electric sensing signal are Direct Current signals.

8. The magnetic sensor device (300) of claim 1,
wherein the different modes of electrically coupling the excitation signal source (303) to the magnetic field generator unit (12) differ with regard to a flow direction of the static electric excitation signal through the magnetic field generator unit (12).

9. The magnetic sensor device (300) of claim 2,
wherein the different modes of electrically coupling the sensing signal source (303) to the sensing unit (11) differ with regard to a flow direction of the static electric sensing signal through the sensing unit (11).

10. The magnetic sensor device (300) of claim 1,
comprising an evaluation unit (315) adapted for electronically evaluating the signal sensed by the sensing unit (11).

11. The magnetic sensor device (800) of claim 10,
wherein the evaluation unit (315) comprises an amplifier unit (801) for amplifying the signal sensed by the sensing unit (11).

12. The magnetic sensor device (1700) of claim 10,
wherein the evaluation unit (315) comprises an evaluation switch unit (1701) for selectively coupling or decoupling the signal sensed by the sensing unit (11) for evaluation.

13. The magnetic sensor device (1700) of claim 12,
wherein the evaluation switch unit (1701) is synchronized with the excitation switch unit (303) and with the sensing switch unit (309).

14. The magnetic sensor device (1700) of claim 12,
wherein at least one of the group consisting of the evaluation switch unit (1701), the excitation switch unit (303), and the sensing switch unit (309) comprises a CMOS chopper circuit.

15. The magnetic sensor device (1900) of claim 10,
wherein the evaluation unit (315) comprises a signal evaluation delay unit (1901) for delaying the signal evaluation by a predetermined time delay value after a switch performed by at least one of the group consisting of the excitation switch unit (303) and the sensing switch unit (309).

16. The magnetic sensor device (1900) of claim 15,
wherein the signal evaluation delay unit (1901) comprises at least one of the group consisting of a sample and hold analog to digital converter, a high speed analog to digital converter, a chopper unit, and a sigma delta converter.

17. The magnetic sensor device (300) of claim 1,
wherein the sensing unit (11) is adapted for sensing the magnetic particles (15) by evaluating the signals sensed in the different modes of coupling the sensing signal source (308) to the sensing unit (11) in combination to thereby suppress at least one of the group consisting of inductive cross-talk and capacitive cross-talk.

18. The magnetic sensor device (300) of claim 1,
wherein the sensing unit (11) is adapted for sensing the magnetic particles (15) based on the Giant Magnetoresistance Effect.

19. The magnetic sensor device (300) of claim 1,
wherein the sensing unit (11) is adapted for quantitatively sensing the magnetic particles (15).

20. The magnetic sensor device (300) of claim 1,
adapted for sensing magnetic beads (15) attached to biological molecules.

21. The magnetic sensor device (300) of claim 1,
adapted as a magnetic biosensor device.

22. The magnetic sensor device (300) of claim 1,
wherein at least a part of the magnetic sensor device (300) is realized as a monolithically integrated circuit.

23. A method of sensing magnetic particles (15), the method comprising
generating a magnetic field by a magnetic field generator unit (12);
supplying a static electric excitation signal to the magnetic field generator unit (12);
switching between different modes of electrically coupling the magnetic field generator unit (12) with the static electric excitation signal;
sensing, by a sensing unit (11), a signal indicative of the presence of the magnetic particles (15) in the generated magnetic field.

24. The method of claim 23,
comprising
supplying a static electric sensing signal to the sensing unit (11);
switching between different modes of electrically coupling the sensing unit (11) with the static electric sensing signal.

25. The method of claim 24,
comprising synchronizing the switching between the different modes of electrically coupling the magnetic field generator unit (12) with the static electric excitation signal and the switching between the different modes of electrically coupling the sensing unit (11) with the static electric sensing signal.

26. A program element, which, when being executed by a processor (20), is adapted to control or carry out a method of sensing magnetic particles (15), the method comprising:
generating a magnetic field by a magnetic field generator unit (12);
supplying a static electric excitation signal to the magnetic field generator unit (12);
switching between different modes of electrically coupling the magnetic field generator unit (12) with the static electric excitation signal;
sensing, by a sensing unit (11), a signal indicative of the presence of the magnetic particles (15) in the generated magnetic field.

27. A computer-readable medium, in which a computer program is stored which, when being executed by a processor (20), is adapted to control or carry out a method of sensing magnetic particles (15), the method comprising:
generating a magnetic field by a magnetic field generator unit (12);
supplying a static electric excitation signal to the magnetic field generator unit (12);
switching between different modes of electrically coupling the magnetic field generator unit (12) with the static electric excitation signal;
sensing, by a sensing unit (11), a signal indicative of the presence of the magnetic particles (15) in the generated magnetic field.
